(19) United States
(12) Patent Application Publication
(10) Pub. No.: US 2023/0244238 A1
(43) Pub. Date: Aug. 3, 2023

(54) MULTIFUNCTIONAL AUTONOMOUS SERVING ROBOT

(71) Applicant: RGT Inc., Daejeon (KR)

(72) Inventor: Ho Jeong JEONG, Daejeon (KR)

(73) Assignee: RGT Inc., Daejeon (KR)

(21) Appl. No.: 17/927,777

(22) PCT Filed: Nov. 25, 2020
(86) PCT No.: PCT/KR2020/016880

§ 371 Date: Nov. 25, 2022

(30) Foreign Application Priority Data
Aug. 31, 2020 (KR) 10-2020-0110626

(51) Int. Cl. G05D 1/02; G01C 21/00

(52) U.S. Cl. CPC G05D 1/0214; G01C 21/383

(57) ABSTRACT

The present invention relates to a multifunctional autonomous serving robot and, more specifically, to a multifunctional autonomous serving robot which has a serving function, and to which additional unique functions other than the serving function can be easily added or modified using an independent module to activate a variety of functions and thus maximize the utility and usefulness of the serving robot.

### TECHNICAL FIELD

The present invention relates to a multifunctional autonomous serving robot and, more specifically, to a multifunctional autonomous serving robot which has a serving function, and to which additional unique functions other than the serving function can be easily added or modified using an independent module to activate a variety of functions and thus maximize the utility and usefulness of the serving robot.

### BACKGROUND ART

In the service industry that provides services such as restaurants, recently, the problem of service response is emerged, and the introduction of a 52-hour workweek and the increase in the minimum wage are in progress, increasing the burden of labor costs. Accordingly, the unmanned service market that does not employ employees has been rapidly expanded.

In particular, a KIOSK, which is an unmanned information guide system for providing unmanned orders and payments, is actively used by the service companies.

However, in a case of the service that provides foods or drinks completed through a cooking or a processing, the development of the unmanned technology is insufficient.

Due to the insufficiency of such technology development, currently, in Korea, the demand for the serving robots is being met by importing and then, selling or leasing the serving robots.

However, since these imported serving robots are rather expensive, one serving robot is a burden on restaurant companies in terms of economic efficiency and productivity.

Therefore, at a time when companies are considering new types of restaurants such as futuristic and unmanned restaurants, there is an urgent need for domestically developed products that are inexpensive and have excellent functions.

By applying intelligent autonomous robot technology that can deliver foods and beverages ordered by customers on behalf of employees in food service companies and restaurant business such as restaurants, coffee shops, fast-food restaurants, family restaurants, and special restaurants, the present invention intends to provide a serving robot that accurately delivers to a customer table, and to provide a multifunctional indoor autonomous technology-applied serving robot that can be easily converted into a robot capable of performing other functions in addition to the serving function and can work 24 hours a day.

In the meantime, as a prior art for multifunctional autonomous serving robot, “a serving robot and a control method thereof” of Korean Patent Laid-Open Publication No. 10-2019-0106910 (hereinafter referred to as “Patent Literature 1”) is disclosed.

Patent Literature 1 relates to a serving robot and a control method thereof of providing the control method for the moving robot includes: a step of receiving user input including a predetermined service request by a moving robot; a step of receiving an article to be served, by the moving robot; a step of extracting a serving position by searching a user and analyzing a user's gesture by the moving robot; a step of extracting the distance and height of the serving position by analyzing an image of the serving position; a step of moving to the serving position and lifting the article to be served to the height of the serving position; and a step of horizontally moving the article to be served to the serving position and placing the article to be served at the serving position.

As another prior art, “a serving robot and a customer serving method using the same” of Korean Patent Laid-Open Publication No. 10-2019-0092337 (hereinafter referred to as “Patent Literature 2”) is disclosed.

In Patent Literature 2, the serving robot incudes a camera for obtaining image data including at least one of an expression and a gesture of a customer associated with food; a microphone for obtaining voice data including a voice of a customer associated with the food; and a processor for obtaining customer response data including at least one of the image data and the voice data through at least one among the camera and the microphone, estimating a response of the customer to the food from the obtained customer response data, and generating or updating customer management information corresponding to the customer on the basis of the estimated response. According to the embodiment, the serving robot can estimate a customer's response from the customer response data through an artificial intelligence-based learning model.

As described above, Patent Literatures 1 and 2 are technologies related to the serving robot that responds to the customer in the field, and has the same technical field as the present invention, however the technical characteristics of the invention are different from each other.

That is, Patent Literatures 1 is a technology for a serving robot that allows the user to directly withdraw the serving article accommodated by the serving robot from the user's desired location to provide it to the user, without withdrawing the serving article by means of the user.

Patent Literature 2 is a technology for a serving robot that can easily identify and manage the tastes of customers using the restaurant, by estimating the customer's response (food-related customer expression and gesture) from customer response data obtained by using a camera or a microphone and updating management information about the customers.

Accordingly, Patent Literature 1 and Patent Literature 2 are different from the present invention in terms of the problem to be solved by the invention, the means for solving the problem, and the effect exerted by solving the problem.

Accordingly, the present invention is different from the technology for the conventional serving robots including the Patent Literature 1 and Patent Literature 2. Also, the present invention seeks to achieve the technical features based on the problem to be solved by the invention (object of the invention), a solution means (element) for solving it, and the effect exerted by solving the same.

### PATENT LITERATURE

Patent Literature 1: Korean Patent Laid-Open Publication No. 10-2019-0106910 (Sep. 18, 2019)
Patent Literature 2: Korean Patent Laid-Open Publication No. 10-2019-0092337 (Aug. 7, 2019)

### DISCLOSURE

### Technical Problem

In this respect, the present invention is made to solve the above-described problem in the related art, and an object thereof is to provide a multifunctional autonomous serving robot to which additional unique functions or particular functions other than the original function (serving function) can be added by mounting an independent module equipped with various unique functions on one side of the serving robot or separating it from the serving robot according to the situation (necessary), thereby maximizing the utility and usefulness of the serving robot.

Another object of the present invention is to provide a multifunctional autonomous serving robot that can quickly respond when the additional unique functions other than the serving function are required according to the needs of the serving robot market.

In other words, by collecting the opinions of the serving robot market, and quickly designing and developing the independent module equipped with the unique functions that meets the opinions, only the independent module is supplied, without purchasing a separate robot, so that the functions required in the field can be immediately applied to the serving robot.

### Technical Solution

According to one aspect of the present invention so as to accomplish these objects, there is provided to a multifunctional autonomous serving robot, including:

a robot body system having a power source means for letting a serving robot move and travel in a predetermined indoor space in accordance with a particular path and a particular signal, an additional function module mounting means for adding a function of the robot to one or more of an upper portion and a lower portion thereof, and a robot control means for controlling the power source means in accordance with the particular path and the particular signal, and a function of a robot added to the additional function module mounting means; and

a robot function attaching/detaching module mounted on and removed from the additional function module mounting means of the robot body system to add or modify a function to the robot, thereby enabling a manager to utilize the robot according to the situation, in such a manner that the manager can easily add a desired function which can be activated along with serving function by using the robot function attaching/detaching module or transform the robot into a robot which performs separate functions as necessary, thereby maximizing applicability and effectiveness of the serving robot.

At this time, the additional function module mounting means is formed such that the robot function attaching/detaching module is detachably attached to one side of the robot body system and is provided with a module mounting interface unit that allows to decipher the unique function of the mounted robot function attaching/detaching module by means of the robot control means in such a manner that the robot function attaching/detaching module and the robot body system are easily connected to each other or separated from each other.

In addition, the robot control means includes:

a serving mode activation unit in which a serving mode, which is already coded as a serving function, is stored;

a module deciphering unit for deciphering information input from the robot function attaching/detaching module; and

a power source control unit for controlling the power source means based on the information transmitted from the serving mode activation unit and the module deciphering unit, and

wherein the module deciphering unit includes:

a module mounting confirmation element for confirming whether the robot function attaching/detaching module is mounted on the additional function module mounting means or not;

a module loading element for deciphering the coded program of the robot function attaching/detaching module mounted on the additional function module mounting means;

an additional function activation element for activating a unique function mode of the robot function attaching/detaching module deciphered by the module loading element;

an additional function mode synchronization determining element for enabling the unique function mode of the robot function attaching/detaching module and the serving mode stored in the serving mode activation unit to be coexisted and activated, enabling the serving mode and the function mode to be alternately activated according to a predetermined time, or enabling only the unique function mode of the robot function attaching/detaching module to be activated, by synchronizing the unique function mode of the robot function attaching/detaching module and the serving mode stored in the serving mode activation unit, in such a manner that the program coded in the robot function attaching/detaching module is deciphered and the robot body system can be controlled according to the deciphered unique function mode of the robot function attaching/detaching module.

In the meantime, it should be understood that the terminology or the words used in claims should not be interpreted in normally or lexically sense. It should be interpreted as meaning and concept consistent with the technical idea of the present invention, based on the principle that the inventor can properly define the concept of the term in order to describe its invention in the best way.

Therefore, the embodiments described in the present specification and the configurations shown in the drawings are only the most preferred embodiments of the present invention, and not all the technical ideas of the present invention are described. Therefore, it is to be understood that various equivalents and modifications are possible.

### Advantageous Effects

As described above with respect to the above configuration and operation, the effects of the present invention are as follows.

1. Independent modules equipped with various unique functions can be easily mounted on or detached from the serving robot, so that it can be utilized as a serving robot with additional unique functions in addition to the serving function.

2. It allows the unique functions of the independent modules mounted on the serving robot to be smoothly activated. (For example, CCTV camera monitoring function, publicity function using 3D hologram projector, etc.)

3. By using the independent modules, a 24-hour serving robot can be utilized according to the situation.

4. Through the independent modules that can be easily mounted on and detached from the serving robot, it is possible to quickly respond to the needs of the serving robot market.

5. In other words, when a new function is required in addition to the original function of the serving robot, only the independent module equipped with the corresponding function is developed and designed and quickly released to the serving robot market, so that consumers can immediately apply the function to the serving robot.

6. Furthermore, ultimately, by constructing an independent module docking station that allows the serving robot to mount and detach the independent module equipped with the particular function by itself according to the function and schedule set by the manager, full automation of serving robots and further growth of the serving robot market can be achieved.

That is, the present invention is a very effective invention that maximizes the utility and usefulness of the serving robot.

### BRIEF DESCRIPTION OF DRAWINGS

The above and other objects, features and advantages of the present invention will be more apparent from the following detailed description taken in conjunction with the accompanying drawings, in which:

FIG. 1 illustrates a conceptual diagram of a multifunctional autonomous serving robot according to the present invention;

FIG. 2 is a diagram illustrating a configuration of a multifunctional autonomous serving robot of the present invention;

FIG. 3 illustrates a first embodiment of a multifunctional autonomous serving robot of the present invention;

FIG. 4 illustrates a second embodiment of a multifunctional autonomous serving robot of the present invention;

FIG. 5 is a schematic diagram of a robot body system among the components of a multifunctional autonomous serving robot of the present invention (FIG. 5 (a) is a conceptual diagram of HAN arrangement and SAN stack and FIG. 5(b) is a conceptual diagram for guidance, navigation, and control thereof).

FIG. 6 is a schematic diagram of an operation flowchart of a multifunctional autonomous serving robot according to the present invention;

FIG. 7 is a schematic block diagram of a robot control means among the components of a multifunctional autonomous serving robot of the present invention;

FIG. 8 is a view illustrating an embodiment of a combination of a robot body system and a robot function attaching/detaching module among the components of a multifunctional autonomous serving robot of the present invention; and

FIG. 9 illustrates another embodiment of a multifunctional autonomous serving robot of the present invention (a conceptual diagram to which a serving robot docking station system (S) is applied is illustrated).

### REFERENCE SIGNS LIST

1: multifunctional autonomous serving robot
100: robot body system
110: power source means
120: additional function module mounting means
121: module mounting interface unit
130: robot control means
131: serving mode activation unit
132: module deciphering unit
132a: module mounting confirmation element
132b: module loading element
132c: additional function activation element
132d: additional function mode synchronization determining element
133: power source control unit
134: driving space creation unit
134a: SLAM execution module
134b: creation map correction module
134c: creation map 2D conversion module
134d: final driving space map creation module
135: path setting unit
135a: driving path execution module
135b: driving path validation module
135c: local/global path return setting module
135d: navigation difference calibration module
136: robot driving control unit
136a: actuator node control module
136b: open board module
136c: control platform porting module
136d: interlocking confirmation module
140: surrounding environment information acquisition sensing means
200: robot function attaching/detaching module
210: module mounting/separating element
220: unique functional expression element
221: security function module object
222: advertisement function module object
223: transport function module object
224: cleaning function module object
225: disinfection function module object
226: air purification function module object
230: unique function coding element
S100: independent module docking step
S200: independent module docking status confirmation step
S300: independent module function mode loading step

### BEST MODE

### Mode for Invention

Hereinafter, functions, configurations, and operations effects of a multifunctional autonomous serving robot (1) according to the present invention will be described in detail with reference to the accompanying drawings.

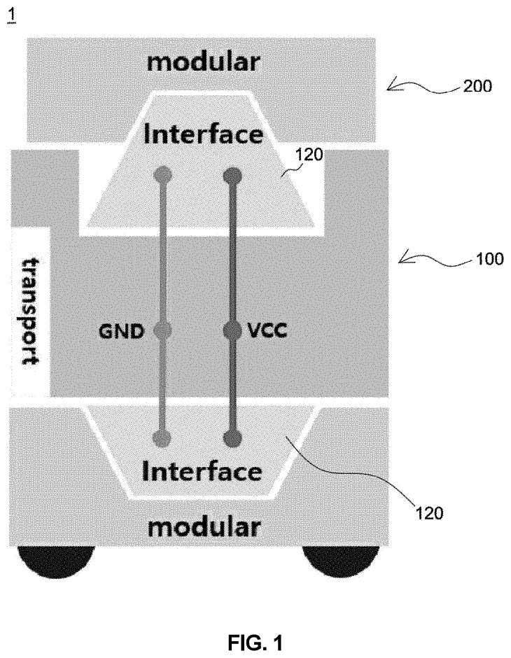

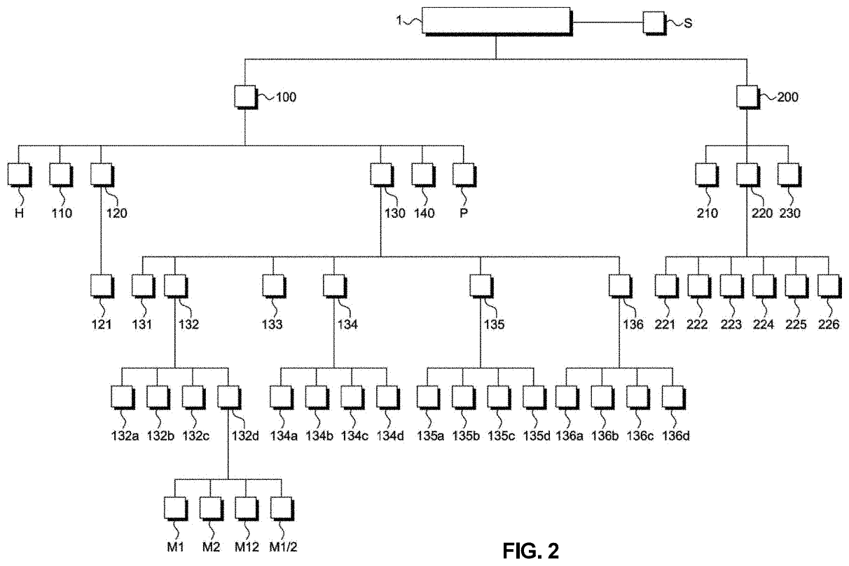

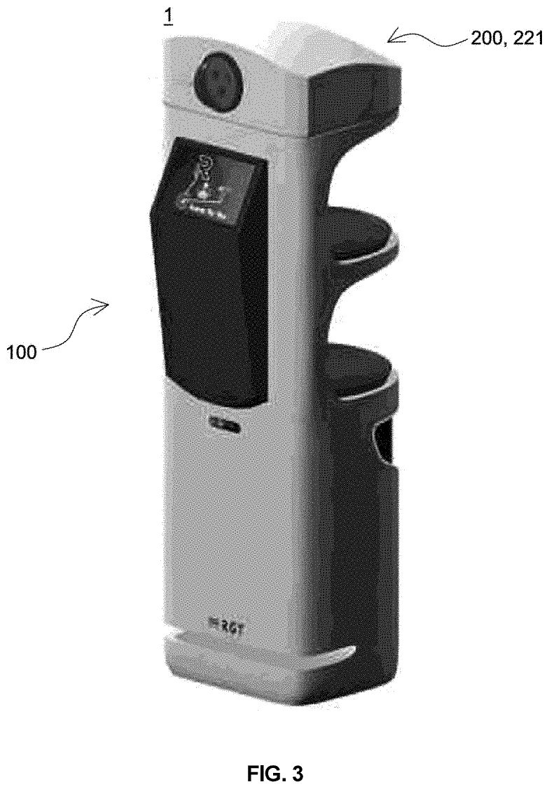

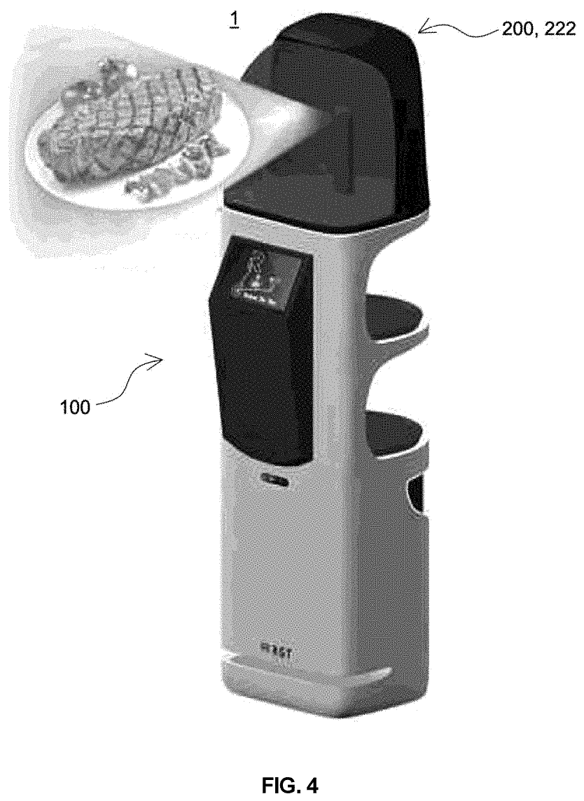

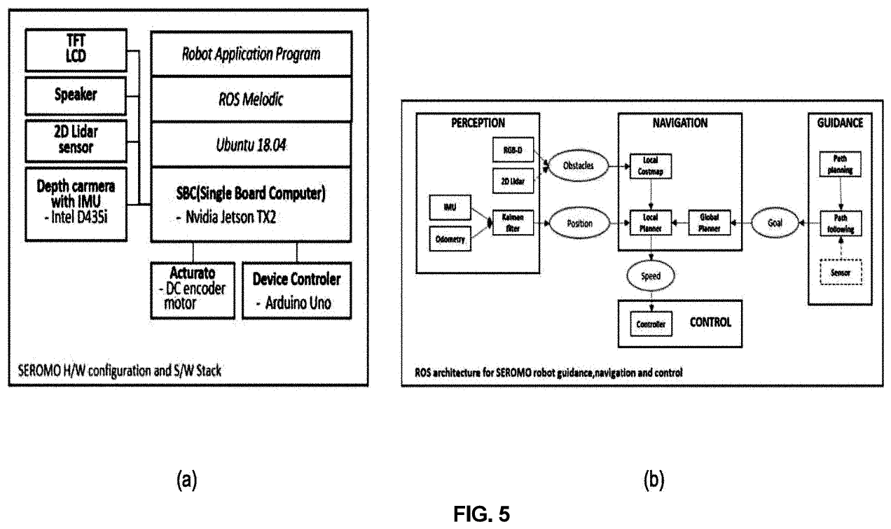

FIG. 1 illustrates a conceptual diagram of a multifunctional autonomous serving robot according to the present invention; FIG. 2 is a diagram illustrating a configuration of a multifunctional autonomous serving robot of the present invention; FIG. 3 illustrates a first embodiment of a multifunctional autonomous serving robot of the present invention; FIG. 4 illustrates a second embodiment of a multifunctional autonomous serving robot of the present invention; and FIG. 5 is a schematic diagram of a robot body system among components of a multifunctional autonomous serving robot according to the present invention.

As shown in FIG. 1 to FIG. 5, the multifunctional autonomous serving robot (1) according to the present invention includes:

a robot body system (100) having a power source means (110) for letting a serving robot move and travel in a predetermined indoor space in accordance with a particular path and a particular signal, an additional function module mounting means (120) for adding a function of the robot to one or more of an upper portion and a lower portion thereof, and a robot control means (130) for controlling the power source means (110) in accordance with the particular path and the particular signal, and a function of a robot added to the additional function module mounting means (120); and

a robot function attaching/detaching module (200) mounted on and removed from the additional function module mounting means (120) of the robot body system (100) to add or modify a function to the robot, thereby enabling a manager to utilize the robot according to the situation.

Accordingly, the manager can easily add a desired function which can be activated along with serving function by using the robot function attaching/detaching module (200) or can transform the robot into a robot which performs separate functions to be utilized as necessary, thereby maximizing applicability and effectiveness of the serving robot.

That is, the present invention relates to a multifunctional autonomous serving robot which has a serving function, and to which additional unique functions other than the serving function can be easily added or modified by mounting an independent module equipped with various unique functions on one side (the additional function module mounting means (120)) of the serving robot or separating it from the serving robot to activate a variety of functions, thereby performing the multiple functions thereof.

The present invention will be described in more detail.

The robot body system (100), as described above, includes:

a serving robot housing (H) formed to perform a serving function;

the power source means (110) positioned and formed in a lower portion of the serving robot housing (H) to let the serving robot move and travel in a predetermined indoor space in accordance with a particular path and a particular signal;

the additional function module mounting means (120) for adding a function of the robot to one or more of an upper portion and a lower portion of the serving robot housing (H); and

the robot control means (130) for controlling the power source means (110) in accordance with the particular path and the particular signal, and a function of a robot added to the additional function module mounting means (120).

On one side of the serving robot housing (H), a surrounding environment information acquisition sensing means (140) for acquiring the surrounding information in real time, and generating and updating spatial information and path information is configured, so that it acquires all information about the serving robot driving. Accordingly, the serving robot can safely operate and drive through the robot control means (130).

Particularly, in the surrounding environment information acquisition sensing means (140), for example, 2D Lidar and RGB-D sensor fusion technologies are applied for the accuracy of the recognition of the dynamic environment of the serving robot.

In addition, the additional function module mounting means (120) is formed such that the robot function attaching/detaching module (200) is detachably attached to one side of the robot body system (100) and is provided with a module mounting interface unit (121) that allows to decipher the unique function of the mounted robot function attaching/detaching module (200) by means of the robot control means (130).

Accordingly, the robot function attaching/detaching module (200) and the robot body system (100) are easily connected to each other or separated from each other.

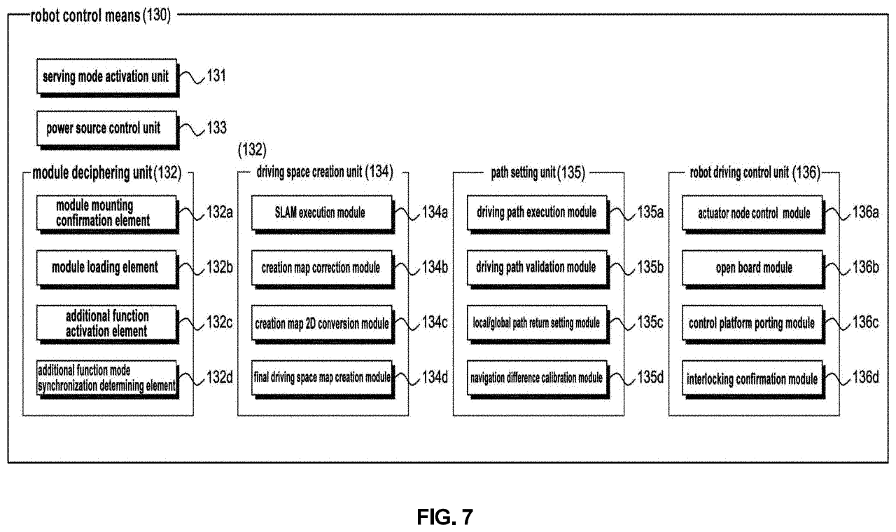

As shown in FIG. 7, the robot control means (130) includes:

a serving mode activation unit (131) in which a serving mode (M1), which is already coded as a serving function, is stored;

a module deciphering unit (132) for deciphering information input from the robot function attaching/detaching module (200); and

a power source control unit (133) for controlling the power source means (110) based on the information transmitted from the serving mode activation unit (131) and the module deciphering unit (132).

In addition, the module deciphering unit (132) includes:

a module mounting confirmation element (132a) for confirming whether the robot function attaching/detaching module (200) is mounted on the additional function module mounting means (120) or not;

a module loading element (132b) for deciphering the coded program of the robot function attaching/detaching module (200) mounted on the additional function module mounting means (120);

an additional function activation element (132c) for activating a unique function mode (M2) of the robot function attaching/detaching module (200) deciphered by the module loading element (132b);

an additional function mode synchronization determining element (132d) for enabling the unique function mode (M2) of the robot function attaching/detaching module (200) and the serving mode (M1) stored in the serving mode activation unit (131) to be coexisted and activated, enabling the serving mode (M1) and the function mode (M2) to be alternately activated according to a predetermined time, or enabling only the unique function mode (M2) of the robot function attaching/detaching module (200) to be activated, by synchronizing the unique function mode (M2) of the robot function attaching/detaching module (200) and the serving mode (M1) stored in the serving mode activation unit (131)

Accordingly, the program coded in the robot function attaching/detaching module (200) is deciphered and the robot body system (100) can be controlled according to the deciphered unique function mode (M2) of the robot function attaching/detaching module (200).

At this time, the additional function mode synchronization determining element (132d) includes:

a serving mode (M1) for activating only serving missions;

a function mode (M2) for activating only a particular unique function of the mounted robot function attaching/detaching module (200);

a multiple mode (M12) for simultaneously activating the serving mode (M1) and the function mode (M2); and

a time difference mode (M1/2) for enabling the serving mode (M1) and the function mode (M2) to be activated according to the schedule set by the manager.

Accordingly, the diversity of functions of the serving robot can be promoted.

In addition, the robot control means (130) is provided with a driving space creation unit (134) that creates a driving space of the serving robot, which is operated and driven by the power source control unit (133), so that it allows the serving robot to autonomously drive a particular space according to a particular signal.

The driving space creation unit (134) includes:

a SLAM execution module (134a) for creating and generating a map of a real-time location and a particular space based on the information obtained from the surrounding environment information acquisition sensing means (140), IMU, and Odometry;

a creation map correction module (134b) for correcting the map of a particular space prepared and created by the SLAM execution module (134a) to improve the accuracy of the driving and operation of the serving robot;

a creation map 2D conversion module (134c) for converting 3D information about the surrounding environment generated by the surrounding environment information acquisition sensing means (140) into 2D information; and

a final driving space map creation module (134d) for creating a driving space map of the serving robot by integrating a result of RTAB-MAP and results of the SLAM execution module (134a), the creation map correction module (134b), and the creation map 2D conversion module (134c) into one 2D map, so that the driving space map of the serving robot can be created,

In addition, a path setting unit (135) for creating and setting a driving path of the serving robot is configured, based on the information created from the driving space creation unit (134).

The path setting unit (135) includes:

a driving path execution module (135a) for performing path planning and path following of the shortest distance according to an input of a target coordinate, to which a probability circle-based spatial search (PCSS) algorithm is applied;

a driving path validation module (135b) for verifying the validity of an IMU dead reckoning and a driving position of the serving robot;

a local/global path return setting module (135c) for setting a return of a local path and a global path by creating a local cost-map for obstacle recognition and avoidance by the surrounding environment information acquisition sensing means (140) while the serving robot is driving; and

a navigation difference calibration module (135d) that performs navigation difference calibration of the serving robot, so that the global and local paths and the driving (navigation) of the serving robot (1) for them are established.

That is, in order for the serving robot to move to its destination, the global path and the local path are required.

The global path means the entire path from the starting point to the destination within the operating environment of the serving robot.

The local path refers to the generation of a local route such as obstacle avoidance by using information detected while the serving robot is moving.

The global path is necessary when the information on all areas of the driving environment is provided and the local path is necessary to ensure the safety of people, assets, and the environment from the serving robot serving close to people.

Accordingly, the present invention performs the detection and tracking of the obstacle using the RGB-D sensor in the obstacle recognition and avoidance method, so as to recognize the location of the 1st-risk cause by contact with a person or other moving component, and manage and detect the 2nd-risk cause of the autonomous driving error in advance.

In addition, by applying the movement trend calculation of the tracked obstacle movement trend calculation and the probability circle-based spatial search (PCSS) algorithm, the movement path of the obstacle after the current point can be predicted.

At this time, the prediction path of the obstacle is used to predict the possibility of collision with the serving robot.

Also, in the movement path of obstacles, it is possible to minimize the meaningless driving of the serving robot and the threat of pedestrians through the creation of a local path considering the mobility of the obstacle and a Kanayama control by calculating the caution cost function through a probabilistic modeling.

Due to this, it is possible to detect and track obstacles quickly and accurately using only the RGB-D sensor information.

Instead of considering only the current location of dynamic obstacles, the probability circle-based spatial search (PCSS) algorithm is applied to allow the actual driving to be performed in a path planning method that considers the mobility of obstacles as well as the driving path.

In other words, by comparing the caution cost function for obstacles, it is possible to create an efficient driving path to the destination with a small threat on pedestrians while driving the serving robot, enabling safe driving even in complex environments with dynamic obstacles.

In addition, the robot control means (130) further includes a robot driving control unit (136) that controls the driving of the serving robot by operating the power source control unit (133) based on the information loaded, generated, and set from the module deciphering unit (132), the driving space creation unit (134), and the path setting unit (135).

The robot driving control unit (136) includes:

an actuator node control module (136a) for forming and controlling a node for controlling the power source means (110);

an open board module (136b) for controlling or monitoring the surrounding environment information acquisition sensing means (140) and the power source means (110);

a control platform porting module (136c) for setting the development tool (arduino IDE) of the open board module (136b) and porting the control platform (ROS_Lib) to the open board module (136b); and

an interlocking confirmation module (136d) that confirms the interlocking of the control platform porting module (136c) for stable operation of the robot driving control unit (136), so that it can control the driving of the serving robot.

At this time, in the open board module (136b), for example, an Arduino ROS serial Multiple Servo OpenCR board may be applied.

The Arduino may be a type of microprocessor board that can input and output to the microprocessor.

On the other hand, the robot function attaching/detaching module (200), which is mounted on and removed from the robot body system(100), and is equipped with various functions so that the serving robot can activate a separate unique function in addition to the serving function.

The robot function attaching/detaching module (200) includes:

a module mounting/separating element (210) that can be mounted on and separated from the module mounting interface unit (121) formed in the additional function module mounting means (120) of the robot body system (100);

a unique function expression element (220) equipped with a particular unique function; and

a unique function coding element (230) in which a particular unique function is coded so that the unique function expression element (220) is activated by the robot control means (130), when the module mounting/separating element (210) is mounted on the module mounting interface unit (121).

Accordingly, by allowing various functions other than the serving function to be exhibited, multiple functions can be performed on the serving robot.

As described above, the module mounting/separating element (210) corresponds to the structure of the module mounting interface unit (121) formed in the additional function module mounting means (120) of the robot body system (100), so that it can be easily mounted and detached.

For example, the unique function expression element (220) includes:

a security function module object (221) for performing a monitoring function having an Infrared CCTV camera;

an advertisement function module object (222) for outputting promotional content and performing a promotional function and having a 3D hologram projector;

a transport function module object (223) that includes a tray capable of transporting a load and performs a transport function;

a cleaning function module object (224) that includes a cleaning device and performs a cleaning function;

a disinfection function module object (225) that includes a quarantine and disinfection device, and performs a quarantine and disinfection function; and

air purification function module object (226) that includes an air purifying device and performs a function of purifying the surrounding air.

In addition, in the unique function coding element (230), as the above-described various unique function expression elements (220) are formed, the unique particular function mode (M2) is coded and formed so as to operate according to its function.

That is, in addition to the serving mode (M1), which is the original function of the serving robot, the multiple functions can be performed simultaneously with the serving mode (M1) or the serving mode (M1) is deactivated according to the situation and the unique function mode (M2) capable of performing other functions is coded and loaded.

For example, the function mode (M2) can be configured in various modes such as a security mode, an advertisement mode, a transport mode, a cleaning mode, a disinfection mode, an air cleaning mode, etc., according to the needs of the market.

That is, as described above, the present invention includes the configuration of the robot body system (100) operated by recognizing and synchronizing the information of the robot function attaching/detaching module (200), which is an independent module capable of various functions so as to perform the multiple functions when the robot function attaching/detaching module (200) is mounted.

It is easy to install and detach the independent module that can easily apply other function modes (M2) other than the serving mode (M1) to the serving robot equipped with the serving mode (M1), which is the original function.

Due to the above structure, the manager can easily add functions other than the serving function to the serving robot so that other functions can be implemented simultaneously with the serving mission.

Or, after the serving mission, it is converted into a serving robot that can perform other functions independently, so that other functions other than serving function can be applied and utilized.

For example, in a case that the security function module object (221) is formed and the robot function attaching/detaching module (200), in which the security mode (M2) is coded, is mounted on the robot body system (100), during the serving time of the serving robot, the serving mission is performed, and when the serving is not required, the infrared CCTV camera is used to monitor a particular space without blind spots.

In addition, in a case that the advertisement function module object (222) is formed and the robot function attaching/detaching module (200), in which the advertisement mode (M2) is coded, is mounted on the robot body system (100), in addition to the serving function, it is possible to output and advertise the promotional content (for example, a cooking video or a finished cooking video, etc.) by using the 3D hologram projector.

The most essential feature of the present invention is an independent modularization of the robot function attaching/detaching module (200).

This is, in addition to the original function of the serving robot in domestic and foreign markets, when a new multiple function is required, only the robot function attaching/detaching module (200) equipped with the necessary function is developed and designed, so that it can quickly respond to the needs and changes of the corresponding market.

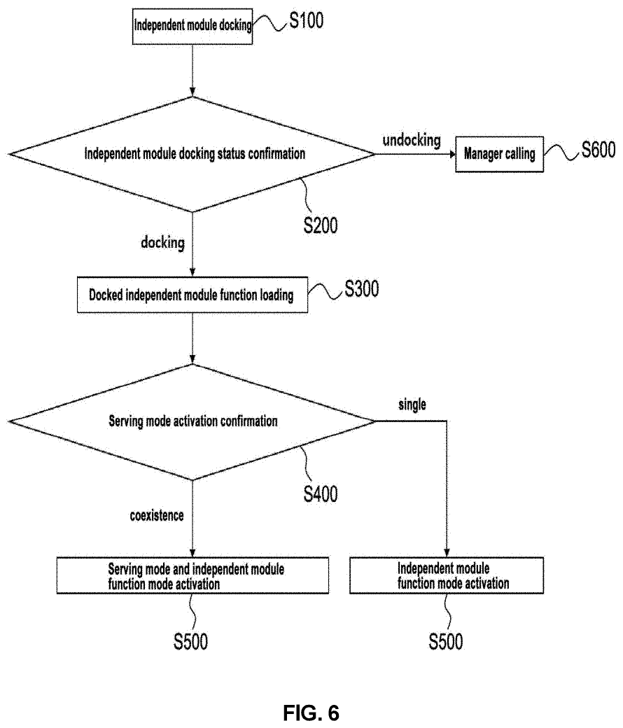

FIG. 6 is a schematic diagram of an operation flowchart of a multifunctional autonomous serving robot according to the present invention.

To be more particular, the operation of the multifunctional autonomous serving robot according to the present invention includes:

an independent module docking step (S100) in which the robot function attaching/detaching module (200) is mounted to the robot body system (100);

an independent module docking status confirmation step (S200) for checking whether the robot function attaching/detaching module (200) is correctly mounted to the robot body system (100), so as to execute the unique function mode (M2) of the robot function attaching/detaching module (200) mounted on the robot body system (100) through the independent module docking step (S100);

an independent module function mode loading step (S300) for loading the information of the unique function mode (M2) from the robot function attaching/detaching module (200) of which the mounting state is confirmed through the independent module docking status confirmation step (S200) in the robot body system (100);

a serving robot multiple function execution confirmation step (S400) for checking whether the serving mode (M1) basically mounted on the robot body system (100) and the unique function mode (M2) loaded from the independent module function mode loading step (S300) are activated or not;

a serving robot multiple function activation step (S500) for activating the serving mode (M1) and the function mode (M2) at the same time or the serving mode (M1) and the function mode (M2) at different times through the serving robot multiple function execution confirmation step (S400); and

a manager calling step (S600) for calling the manager to correctly mount the robot function attaching/detaching module (200) thereon, when the mounting status of the robot function attaching/detaching module (200) is unstable from the independent module docking status confirmation step (S200).

In addition, according to an additional aspect of the present invention, the robot body system (100) further includes an emotional speech providing output means (P) that allows a conversation with the customer while serving the food ordered to the table customers, in consideration of the sensitivity of the customer contact point.

For example, information is received from a location based service (LBS) of the Korea Meteorological Administration and a simple greeting can be expressed to the customers according to the weather every day using a display and a speaker.

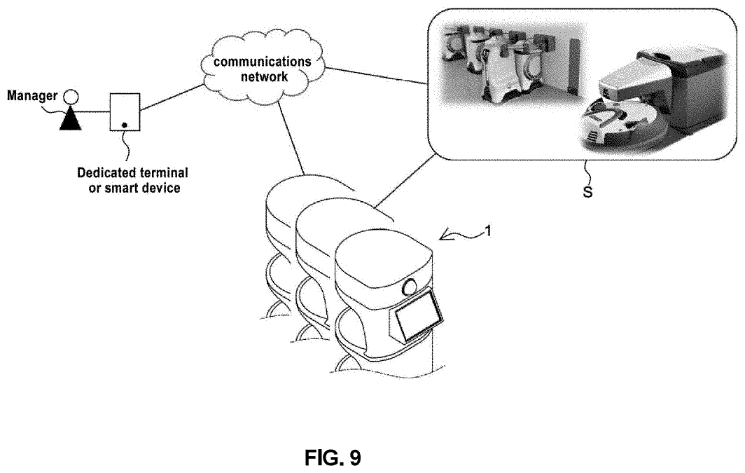

Also, ultimately, as shown in FIG. 9, the multifunctional autonomous serving robot (1) of the present invention allows the robot function attaching/detaching module (200) equipped with the particular unique function mode (M2) to be mounted on or separated from the robot body system by itself by the scheduling of the manager and the serving mode (M1) and the function mode (M2) are activated according to the schedule, so that the serving robot docking station system (S) that can perform its function is built.

Accordingly, through a dedicated terminal or a smart device, the manager plans and sets schedules, and simply transmits the planned and set scheduling information to the serving robot docking station system (S) or the robot body system (100), so that it can control the function and the operation of the multifunctional autonomous serving robot (1) according to the schedule thereof.

For reference, a robot operating system (ROS) software platform may be applied to the robot control means (130) of the multifunctional autonomous serving robot (1) of the present invention.

The ROS is a meta operating system that provides libraries, various development, and debugging tools necessary for the development environment, such as hardware abstraction, device control, sensing and recognition, map creation, motion planning, process message passing, and package management required for robot application programs.

The ROS is also convenient to use for development on a PC, since it runs on an OS such as Ubuntu.

A typical SBC (single board computer) such as Raspberry Pi, ODROID, Intel Edison, BeagleBone, TX2, etc. required for ROS operation in the actual robot is used.

On the other hand, in the case of serving robots to lower the development cost, since 8-bit MCUs such as AVR are used, there are many difficulties in the hardware configuration and the program development of the robot operation, and the accuracy of the position recognition and driving of the robot are also greatly reduced.

Accordingly, in the present invention, the hardware configuration uses Nvidia Jetson TX2 (8 GB) SBC and Ubuntu 16.04, ROS Melodic as OS is loaded, so that the most safe and reliable hardware and software platform can be configured in serving robot application development and driving technology.

In addition, the power source means (110) of the present invention means a set of mechanical elements that must be physically operated in order to perform the movement of the serving robot (1) according to the operation of wheels, shafts, motors, robot arms, etc., the particular mission (serving mode (M1)), the function mode (M2), the multiple mode (M12), and the time difference mode (M1/2))

In addition, the ‘particular path’ in the present invention means driving space information and driving path information created by the robot control means (130), particularly, the driving space creation unit (134), and the path setting unit (135).

Also, the ‘particular signal’ means a control signal transmitted and inputted from the robot control means (130), particularly, the power source control unit (133) and the robot driving control unit (136).

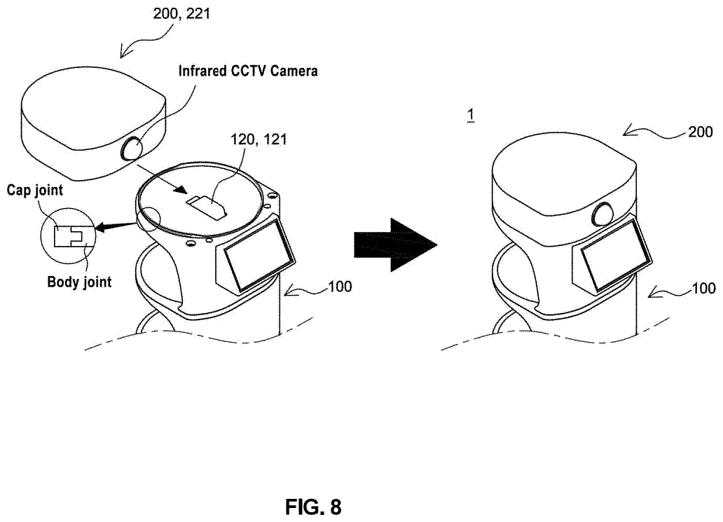

FIG. 8 shows an example of a coupling structure between a robot body system and a robot function attaching/detaching module among the components of a multifunctional autonomous serving robot, that is, a coupling structure that is mounted and separated by a slide method according to the present invention.

As described above, the present invention is not limited to the described embodiment, and it is obvious for those who have common knowledge in the art to variously modify and change the present invention without departing from the idea and the scope of the present invention.

Hence, since the present invention can be realized as various embodiments without departing from the technical idea or the major feature, the embodiments of the present invention are only provided as simple examples and are not to be construed narrowly but can be variously modified.

### INDUSTRIAL APPLICABILITY

The present invention relates to a multifunctional autonomous serving robot and can be applied to an improvement in the robot hardware and software industry developed and manufactured for the main purpose of service, in particular, the hardware and software industry of the serving robot.

1. A multifunctional autonomous serving robot, comprising:
a robot body system (100) having a power source means (110) for letting a serving robot move and travel in a predetermined indoor space in accordance with a particular path and a particular signal, an additional function module mounting means (120) for adding a function of the robot to one or more of an upper portion and a lower portion thereof, and a robot control means (130) for controlling the power source means (110) in accordance with the particular path and the particular signal and a function of a robot added to the additional function module mounting means (120); and
a robot function attaching/detaching module (200) mounted on and removed from the additional function module mounting means (120) of the robot body system (100) to add or modify a function to the robot, thereby enabling a manager to utilize the robot according to the situation, in such a manner that the manager can easily add a desired function which can be activated along with serving function by using the robot function attaching/detaching module (200) or transform the robot into a robot which performs separate functions as necessary, thereby maximizing applicability and effectiveness of the serving robot,
wherein the robot body system (100) includes:
a serving robot housing (H) formed to perform a serving function;
the power source means (110) positioned and formed in a lower portion of the serving robot housing (H) to let the serving robot move and travel in a predetermined indoor space in accordance with the particular path and the particular signal;
the additional function module mounting means (120) for adding a function of the robot to one or more of an upper portion and a lower portion of the serving robot housing (H); and
the robot control means (130) for controlling the power source means (110) in accordance with the particular path and the particular signal and the function of the robot added to the additional function module mounting means (120),
wherein on one side of the serving robot housing (H), a surrounding environment information acquisition sensing means (140) for acquiring surrounding information in real time, and generating and updating spatial information and path information is configured, so that it acquires all information about the serving robot driving, thereby safely operating and driving through the robot control means (130),
wherein in the surrounding environment information acquisition sensing means (140), 2D Lidar and RGB-D sensor fusion technologies are applied for an accuracy of the recognition of a dynamic environment of the serving robot,
wherein the additional function module mounting means (120) is formed such that the robot function attaching/detaching module (200) is detachably attached to one side of the robot body system (100) and is provided with a module mounting interface unit (121) that allows to decipher the unique function of the mounted robot function attaching/detaching module (200) by means of the robot control means (130), so that the robot function attaching/detaching module (200) and the robot body system (100) are easily connected to each other or separated from each other,
wherein the robot control means (130) includes:
a serving mode activation unit (131) in which a serving mode (M1), which is already coded as a serving function, is stored;
a module deciphering unit (132) for deciphering information input from the robot function attaching/detaching module (200); and
a power source control unit (133) for controlling the power source means (110) based on the information transmitted from the serving mode activation unit (131) and the module deciphering unit (132),
wherein the module deciphering unit (132) includes:
a module mounting confirmation element (132a) for confirming whether the robot function attaching/detaching module (200) is mounted on the additional function module mounting means (120) or not;
a module loading element (132b) for deciphering the coded program of the robot function attaching/detaching module (200) mounted on the additional function module mounting means (120);
an additional function activation element (132c) for activating a unique function mode (M2) of the robot function attaching/detaching module (200) deciphered by the module loading element (132b);
an additional function mode synchronization determining element (132d) for enabling the unique function mode (M2) of the robot function attaching/detaching module (200) and the serving mode (M1) stored in the serving mode activation unit (131) to be coexisted and activated, enabling the serving mode (M1) and the function mode (M2) to be alternately activated according to a predetermined time, or enabling only the unique function mode (M2) of the robot function attaching/detaching module (200) to be activated, by synchronizing the unique function mode (M2) of the robot function attaching/detaching module (200) and the serving mode (M1) stored in the serving mode activation unit (131), so that the program coded in the robot function attaching/detaching module (200) is deciphered and the robot body system (100) can be controlled according to the deciphered unique function mode (M2) of the robot function attaching/detaching module (200),
wherein the additional function mode synchronization determining element (132d) includes:
a serving mode (M1) for activating only serving missions;
a function mode (M2) for activating only a particular unique function of the mounted robot function attaching/detaching module (200);
a multiple mode (M12) for simultaneously activating the serving mode (M1) and the function mode (M2); and
a time difference mode (M1/2) for enabling the serving mode (M1) and the function mode (M2) to be activated according to the schedule set by the manager, so that the diversity of functions of the serving robot can be promoted,
wherein the robot control means (130) is provided with a driving space creation unit (134) that creates a driving space of the serving robot, which is operated and driven by the power source control unit (133), so that it allows the serving robot to autonomously drive a particular space according to the particular signal,
wherein the driving space creation unit (134) includes:
a SLAM execution module (134a) for creating and generating a map of a real-time location and a particular space based on the information obtained from the surrounding environment information acquisition sensing means (140), IMU, and Odometry;
a creation map correction module (134b) for correcting the map of a particular space prepared and created by the SLAM execution module (134a) to improve the accuracy of the driving and operation of the serving robot;
a creation map 2D conversion module (134c) for converting 3D information about the surrounding environment generated by the surrounding environment information acquisition sensing means (140) into 2D information; and
a final driving space map creation module (134d) for creating a driving space map of the serving robot by integrating results of the SLAM execution module (134a), the creation map correction module (134b), and the creation map 2D conversion module (134c) into one 2D map, so that the driving space map of the serving robot can be created,
wherein a path setting unit (135) for creating and setting a driving path of the serving robot is configured, based on the information created from the driving space creation unit (134), and
wherein the path setting unit (135) includes:
a driving path execution module (135a) for performing path planning and path following of the shortest distance according to an input of a target coordinate, to which a probability circle-based spatial search (PCSS) algorithm is applied;
a driving path validation module (135b) for verifying the validity of an IMU dead reckoning and a driving position of the serving robot;
a local/global path return setting module (135c) for setting a return of a local path and a global path by creating a local cost-map for obstacle recognition and avoidance by the surrounding environment information acquisition sensing means (140) while the serving robot is driving; and
a navigation difference calibration module (135d) that performs navigation difference calibration of the serving robot, so that the global and local paths and the navigation of the serving robot (1) for them are established.

2. (canceled)

3. (canceled)
